(19) United States
(12) Patent Application Publication
(10) Pub. No.: US 2012/0101758 A1
(43) Pub. Date: Apr. 26, 2012

(54) METHOD OF ANALYZING CAUSE OF ABNORMALITY AND PROGRAM ANALYZING ABNORMALITY

(75) Inventor: Tatsuya OGI, Kurokawa-gun (JP)

(73) Assignee: TOKYO ELECTRON LIMITED, Tokyo (JP)

(21) Appl. No.: 13/279,660

(22) Filed: Oct. 24, 2011

Related U.S. Application Data
(60) Provisional application No. 61/413,508, filed on Nov. 15, 2010.

(30) Foreign Application Priority Data
Oct. 25, 2010 (JP) 2010-238097

(51) Int. Cl. G06F 19/00

(52) U.S. Cl. 702/81

(57) ABSTRACT

A method of analyzing a cause of abnormality of a wafer processed by plasma in at least any one of two or more process modules disposed in a plasma processing system of a cluster type, the method includes recording information about transfer paths of the processing target from when the wafer is transferred from a shipping container and transferred to at least any one of the two or more process modules to when the processing target is returned to the shipping container, in relation with identification information of the wafer for each processing target; testing a state of the wafer after a plasma process has finished; and analyzing a cause of abnormality based on a result of comparison between recorded informations about transfer paths of the processing target determined to be abnormal and the processing target determined to be normal as a result of the testing.

### CROSS-REFERENCE TO RELATED PATENT APPLICATIONS

This application claims the benefits of Japanese Patent Application No. 2010-238097, filed on Oct. 25, 2010 in the Japan Patent Office, and the U.S. Patent Application No. 61/413,508, filed on Nov. 15, 2010 in the U.S. Patent and Trademark Office, the disclosures of which are incorporated herein in its entirety by reference.

### BACKGROUND OF THE INVENTION

1. Field of the Invention

The present invention relates to a method of analyzing causes of abnormality of a processing target after a plasma process and a program analyzing an abnormality.

2. Description of the Related Art

In a general plasma processing apparatus, it may be managed, with respect to wafer units, which process is to be performed on a wafer by using wafer identification information such as wafer identification (ID). For example, processes are managed by reading wafer ID by using a barcode or the like, and executing a process recipe corresponding to the wafer ID.

For example, Patent Reference 1 discloses a technology of defining a recipe discrimination mark to discriminate wafers in sheet units by forming the recipe discrimination mark on a surface of a wafer, and performing an automatic process on each of the wafers based on a recipe corresponding to the defined recipe discrimination mark. That is, a mark for discriminating a process recipe is attached on a wafer so as to set the recipe automatically.

In addition, for example, Patent Reference 2 discloses a wafer ID readable multi-chamber apparatus capable of setting processing conditions of wafers and managing a processing state automatically. A wafer ID reader is disposed in the chamber itself, and thus a processing recipe may be automatically set while transferring wafers.

However, in managing processes of semiconductors, which are proceeded more fine recently, there are a lot of problems that may not be solved by the prior art in which processes performed on wafers are simply managed.

For example, when a state of a wafer has been analyzed after a plasma process, if processing state of a surface of the wafer is degraded because particles are deposited on the wafer or the surface of the wafer is etched by residual gas used during the plasma process, the above methods of the prior art may not solve the above problems.

The above problems are mainly generated because a certain plasma processing chamber or a front opening unified pod that receives wafers becomes a contamination source, and thus in order to analyze causes of the above problems, information about a transfer path of a wafer, as well as information about a process performed on the wafer, is necessary.

3. Prior Art Reference
(Patent Reference 1) Japanese Patent Laid-open Publication No. hei 05-114534
(Patent Reference 2) Japanese Patent Laid-open Publication No. hei 06-267809

### SUMMARY OF THE INVENTION

The present invention provides a method of analyzing causes of abnormality and a program analyzing an abnormality, which are capable of analyzing causes of abnormality of a wafer that has been processed by plasma.

According to an aspect of the present invention, there is provided a method of analyzing a cause of abnormality of a processing target processed by plasma in at least any one of two or more processing chambers disposed in a plasma processing system of a cluster type, the method including: recording information about transfer paths of the processing target from when the processing target is transferred from a shipping container and transferred to at least any one of the two or more processing chambers to when the processing target is returned to the shipping container, in relation with identification information of the processing target for each processing target; testing a state of the processing target after a plasma process has finished; and analyzing a cause of abnormality based on a result of comparison between a recorded information about a transfer path of the processing target that is determined to be abnormal and a recorded information about a transfer path of the processing target that is determined to be normal as a result of the testing.

According to the method, information about the transfer path of each processing target may be recorded in relation with identification information of the processing target. Accordingly, as a result of the test, the information about the transfer path of the processing target that is determined to be abnormal and the information about the transfer path of the processing target that is determined to be normal may be compared with each other, and a cause of abnormality may be analyzed based on the comparison result.

The analyzing of the cause of abnormality may be performed based on a difference of the transfer paths between the information about the recorded transfer path of the processing target determined to be abnormal and the information about the recorded transfer path of the processing target determined to be normal.

The recording may record a time during which the processing target transferred along the transfer path stays in each of chambers on the transfer path, and the analyzing of the cause of abnormality may be performed based on a difference between a recorded staying time of the processing target determined to be abnormal in each of the chambers and a recorded staying time of the processing target determined to be normal in each of the chambers.

The testing may be for detecting particles on the processing target after the plasma process has finished.

The testing may be for checking a shape of a film on the processing target after the plasma process has finished.

The plasma processing system may include two or more transfer arms transferring respectively the processing target in a transfer chamber connecting the two or more processing chambers.

The plasma processing system may include two or more loadlock modules connecting a processing side system including the two or more processing chambers and a transfer side system.

According to another aspect of the present invention, there is provided a non-transitory computer-readable medium having embodied thereon a program analyzing an abnormality for executing a function of analyzing a cause of abnormality of a processing target processed by plasma in at least any one of two or more processing chambers disposed in a plasma processing system of a cluster type, wherein the function of analyzing the cause of abnormality may include: recording information about transfer paths of the processing target from when the processing target is transferred from a shipping container and transferred to at least any one of the two or more processing chambers to when the processing target is returned to the shipping container, in relation with identification information of the processing target for each processing target; testing a state of the processing target after the a plasma process has finished; and analyzing a cause of abnormality based on a result of comparison between a recorded information about a transfer path of the processing target that is determined to be abnormal and a recorded information about a transfer path of the processing target that is determined to be normal as a result of the testing.

According to another aspect of the present invention, there is provided an apparatus for analyzing a cause of abnormality of a processing target processed by plasma in at least any one of two or more processing chambers provided in a plasma processing system of a cluster type, the apparatus including: a recording unit for storing information about transfer paths of the processing target from when the processing target is transferred from a shipping container and transferred to at least any one of the two or more processing chambers to when the processing target is returned to the shipping container, in relation with identification information of the processing target for each processing target; a tester for testing a state of the processing target after a plasma process has finished; and a controller for analyzing a cause of abnormality based on a result of comparison between a recorded information about a transfer path of the processing target that is determined to be abnormal and a recorded information about a transfer path of the processing target that is determined to be normal as a result of the testing.

### BRIEF DESCRIPTION OF THE DRAWINGS

The above and other features and advantages of the present invention will become more apparent by describing in detail exemplary embodiments thereof with reference to the attached drawings in which:

FIG. 1 is an entire block diagram of a plasma processing system of a cluster type according to an embodiment of the present invention;

FIG. 2 is a block diagram of hardware in an equipment computer according to an embodiment of the present invention;

FIG. 3 is a diagram showing an example of a screen displayed on the equipment computer according to an embodiment of the present invention;

FIG. 4 is a diagram showing another example of the screen displayed on the equipment computer according to an embodiment of the present invention;

FIG. 5 is a diagram showing another example of the screen displayed on the equipment computer according to an embodiment of the present invention;

FIG. 6 is a flowchart showing processes of analyzing causes of abnormality executed in the equipment computer according to an embodiment of the present invention;

FIG. 7 is a diagram showing an example of a transfer path in the plasma processing system according to an embodiment of the present invention;

FIG. 8 is a diagram showing another example of the transfer path in the plasma processing system according to an embodiment of the present invention;

FIG. 9 is a flowchart showing processes of analyzing causes of abnormality executed in an equipment computer according to another embodiment of the present invention; and

FIG. 10 is a diagram showing an example of a transfer path in a plasma processing system according to another embodiment of the present invention.

### DETAILED DESCRIPTION OF THE INVENTION

Hereinafter, the present invention will be described in detail by explaining exemplary embodiments of the invention with reference to the attached drawings. Also, in the specification and the drawings, elements having substantially the same functions and configurations are denoted by the same reference numerals and thus a repeated explanation thereof will not be given.

### An Embodiment

### Entire Structure of a Plasma Processing System of a Cluster Type

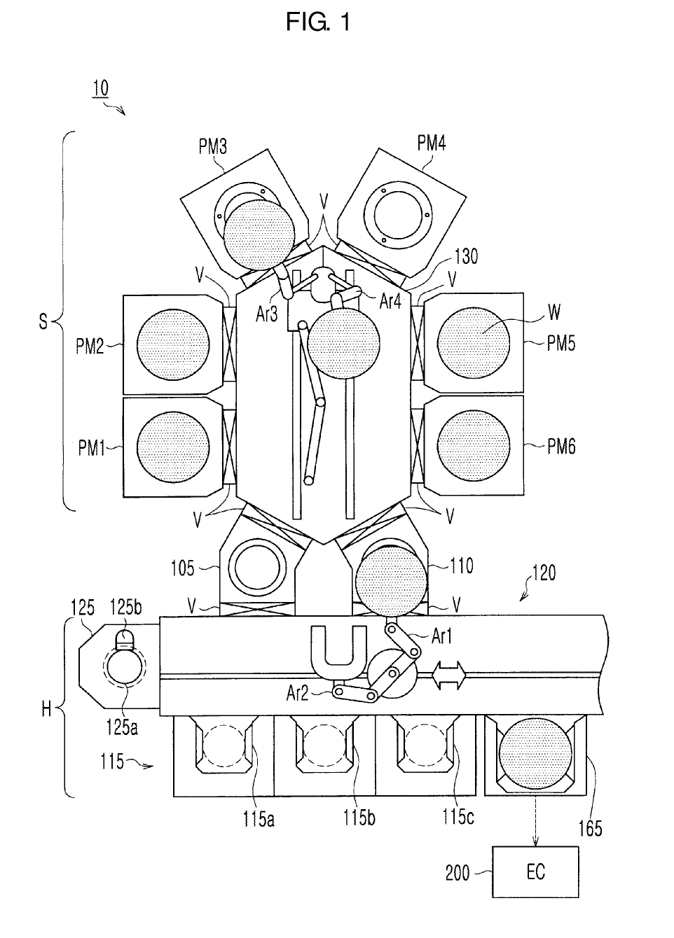

An entire structure of a plasma processing system of a cluster type according to an embodiment of the present invention will be described with reference to FIG. 1.

A plasma processing system 10 of a cluster type includes a transfer side system H that transfers wafers W and a process side system S that performs substrate processes such as a film-forming process or an etching process on the wafers W. The transfer side system H and the process side system S are connected to each other via loadlock modules (LLMs) 105 and 110. In the present embodiment, there are two LLMs; however, three or more LLMs may be provided.

The transfer side system H includes a container holding stage 115 and a load module 120. Three shipping containers 115a through 115c are placed on the container holding stage 115. The shipping containers 115a through 115c are containers for receiving the plurality of wafers W. Also, a shipping container is hereinafter referred to as a front opening unified pod (FOUP).

The load module 120 supports two transfer arms Ar1 and Ar2 that are stretchable and swivelable, and the two transfer arms Ar1 and Ar2 are slid by magnetic driving. One of the transfer arms Ar1 and Ar2 holds a wafer W by using a fork that is disposed to a leading end thereof, and slides on rails of the load module 120.

A location alignment unit 125 that determines a location of the wafer W is provided on a leading end of the load module 120. The location alignment unit 125 detects a state of a peripheral portion of the wafer W by using an optical sensor 125b while rotating a rotary holding stage 125a in a state where the wafer W is placed on the rotary holding stage 125a, so that the location of the wafer W is aligned.

A holding stage on which the wafer W is placed is provided in each of the LLMs 105 and 110, and gate valves V that may be opened/closed air-tightly are provided on opposite end portions of each of the LLMs 105 and 110. Through the above described structure, the transfer side system H transfers the wafer W between the FOUPs 115a through 115c, the LLMs 105 and 110, and the location alignment unit 125.

In the present embodiment, a transfer chamber (T/C) 130 and six process modules PM1 through PM6 are provided in the process side system S. The process modules PM1 through PM6 are examples of a processing chamber in which a process such as an etching process is performed according to a certain recipe. Six processing modules are disposed according to the present embodiment; however, the present invention is not limited thereto, that is, two or more processing modules may be disposed in the process side system S.

The T/C 130 is connected to each of the process modules PM1 through PM6 via gate valves V that are opened/closed air-tightly. Transfer arms Ar3 and Ar4 that are stretchable and swivelable are provided in the T/C 130. The T/C 130 is an example of a transfer chamber that connects two or more processing chambers. The transfer arms Ar3 and Ar4 are examples of transfer arms that respectively transfer the wafer W in the transfer chamber, and three or more transfer arms may be provided.

According to the above described structure, one of the transfer arms Ar3 and Ar4 transfers the wafer W from one of the LLMs 105 and 110 into one of the process modules PM1 through PM6 via the T/C 130. The wafer W is processed, for example, etched in one of the process modules PM1 through PM6, and held by a fork that is disposed to a leading end of one of the transfer arms Ar3 and Ar4 to be placed on the holding stage in one of the LLMs 105 and 110.

One of the transfer arms Ar1 and Ar2 of the load module 120 holds the wafer W placed on the holding stage in one of the LLMs 105 and 110 by using the fork disposed to the leading end thereof, and slides on the rails of the load module 120. Accordingly, the wafer W, which is held, is returned to the FOUP 115a.

The wafer W after having been processed is transferred into a tester 165 disposed to a side of the load module 120, and placed on a holding stage. The tester 165 examines a state of a processed wafer W to evaluate plasma processing results of each wafer W. Examples of a test performed by the tester 165 may be a test for detecting particles on the processed wafer W or a test regarding a shape of the processed wafer W. In the test for detecting particles, if there are particles deposited on a surface of the wafer W placed on the holding stage, when laser beams are irradiated onto the particles, dispersed light is generated. A part of the dispersed light is received by a light receiving unit (not shown), and is converted into an electric signal by a photoelectric conversion unit (not shown). The electric signal is transmitted to an equipment computer 200. Since an intensity of the dispersed light varies depending on a size of a particle, the equipment computer 200 detects existence of the particle and the size of the particle based on a voltage value of the electric signal corresponding to the intensity of the dispersed light. If it is determined that the wafer W has no abnormality after the test, the wafer W is returned to the FOUP 115a, 115b, or 115c.

The tester 165 may test a shape of the wafer W. For example, the wafer W may be divided so that a cross-sectional state of the wafer W may be tested, or a fault processed on the wafer W may be optically tested.

(Hardware Configuration of an Equipment Computer)

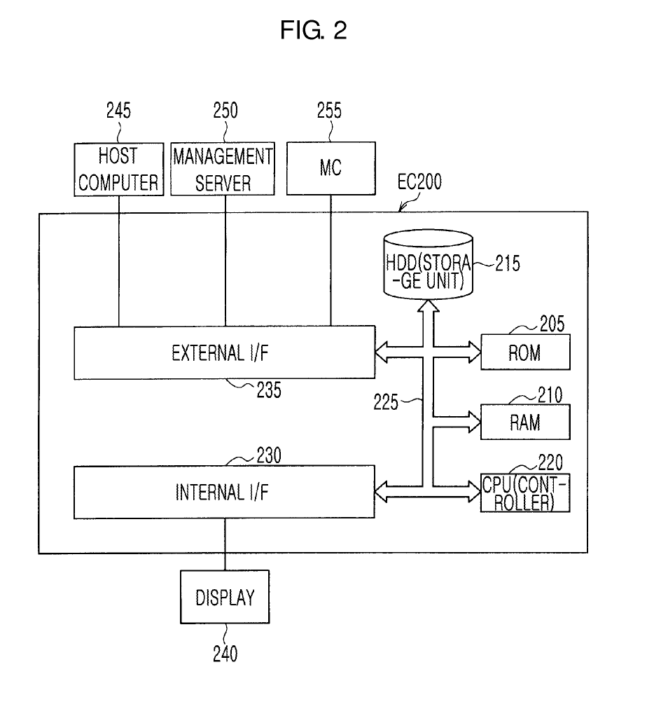

A hardware configuration of an equipment computer (EC) 200 will be described with reference to FIG. 2. The EC 200 includes a read only memory (ROM) 205, a random access memory (RAM) 210, a hard disk drive (HDD) 215, a central processing unit (CPU) 220, a bus 225, an internal interface (I/F) 230, and an external interface (I/F) 235. The EC 200 corresponds to an apparatus for analyzing causes of abnormality of wafer processed by plasma in at least one of the two or more processing chambers disposed in the plasma processing system of the cluster type.

The ROM 205 and the RAM 210 store programs for controlling transferring or processing of the wafer, various recipes, and a variety of data. In addition, the ROM 205 and the RAM 210 are examples of a memory device, and memory devices such as an electrically erasable programmable ROM (EEPROM), an optical disk, and a magneto-optical disk may be used.

The CPU 220 controls the transferring and the processing of the wafer W according to the various recipes. The bus 225 is a path through which data is exchanged among devices such as the ROM 205, the RAM 210, the HDD 215, the CPU 220, the internal I/F 230, and the external I/F 235. The CPU 220 corresponds to a controller that compares an information recording a transfer path of a wafer that is determined to be abnormal as a result of the test performed by the tester 165 with an information recording a transfer path of a wafer that is determined to be normal, and analyzes causes of abnormality based on a comparison result.

The internal I/F 230 inputs a history information recording the transfer path to display the history information on a display 240. The external I/F 235 transmits/receives data to/from a host computer 245, a management server 250, and a machine controller (MC) 255.

The plasma processing system 10 of the cluster type may perform processes according to regulations of substrate tracking standard E90. According to the regulations, the history information of the transfer path showing where and how the wafer passes through the cluster type plasma processing system 10 is sent to the host computer 245 from the plasma processing system 10 in relation to wafer identification information. In the present embodiment, the history information about the transfer path is stored in the HDD 215 in relation to the wafer identification information at the same time as when the wafer W returns to the FOUP. That is, the HDD 215 stores the wafer identification information (for example, a wafer ID) and the history information of the transfer path in relation to each other. The HDD 215 is an example of a memory unit that stores the information about the transfer path of each wafer from when the wafer is transferred from the FOUP and transferred to at least any one of the processing chambers, to a time point when the wafer is returned to the FOUP, in relation to the identification information of the corresponding wafer.

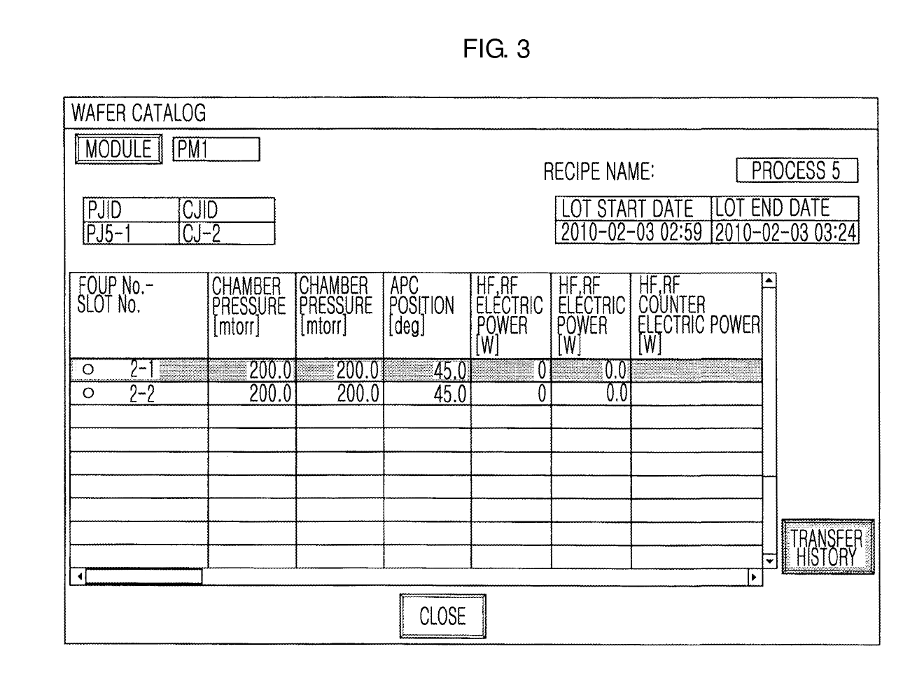

FIGS. 3 through 5 are examples of screens displayed on the display 240. FIG. 3 is a screen showing a wafer catalog. In the wafer catalog, a process job ID (PJID) and a control job ID (CJID) are displayed on an upper left portion. The PJID relates to a combination of a process recipe (processing condition) and a slot number. The CJID relates to a number of the FOUP. Therefore, what location in what FOUP the wafer exists may be defined by combining the PJID and the CJID. Moreover, it may be defined which process is performed from the process recipe of the PJID.

For example, in FIG. 3, it may be identified that the wafer placed on a slot No. 1, as denoted by the PJID, in a FOUP No. 2, as denoted by the CJID, is processed according to a process recipe (recipe name: process 5) of PJ5, as denoted by the PJID. As described above, according to the present embodiment, the combination of the PJID and the CJID is set as the wafer identification information.

However, the present invention is not limited thereto, that is, the wafer identification information may be any kind of information, provided that the information may define the wafer. For example, an individual wafer may be managed simply by a wafer ID.

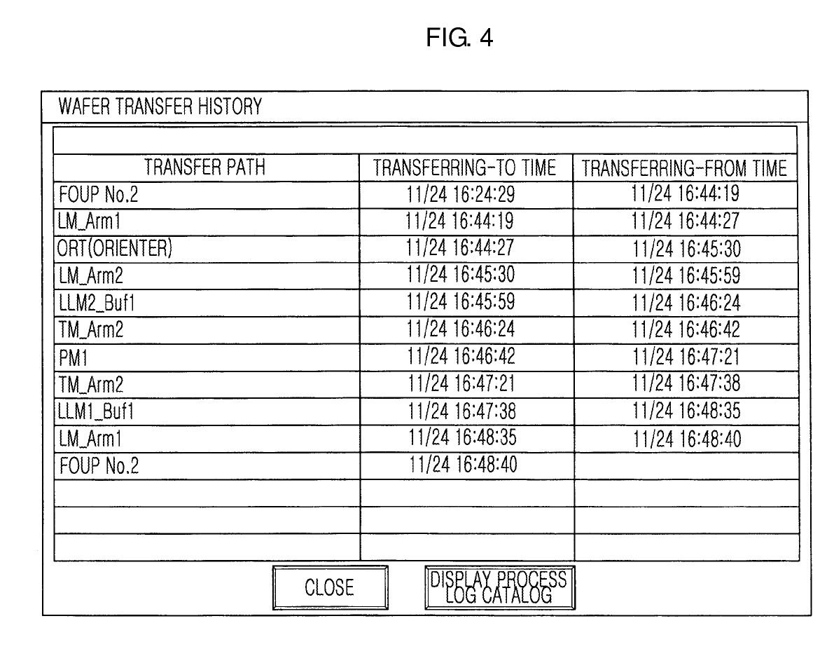

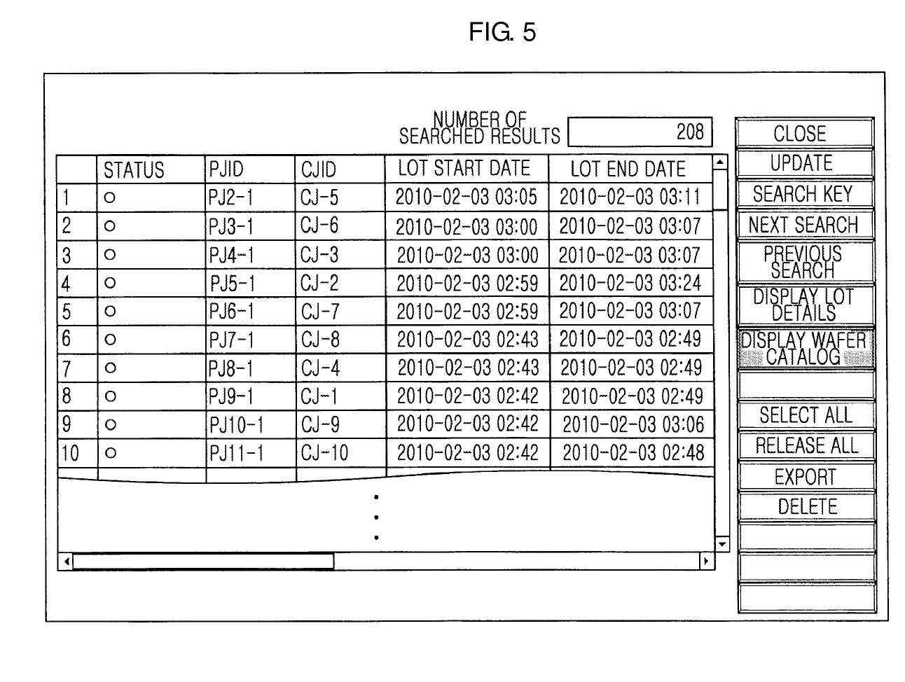

A processing condition in which the wafer W is transferred from the FOUP No. 2 and the slot No. 1 and processed in the process module PM1 is represented in a first row of the wafer catalog. A second row of the wafer catalog represents a processing condition in which the wafer W is transferred from the FOUP No. 2 and the slot No. 2. FIG. 4 is a screen showing a transfer path of the wafer W that is transferred from the FOUP No. 2 and has the wafer identification information defined by the wafer catalog of FIG. 3. FIG. 5 is a screen showing a process log catalog.

In order to display the screen showing the transfer path, the wafer catalog screen of FIG. 3 is displayed so that an operator may select a processing condition representing a number of a normal wafer or an abnormal wafer, and push a transfer history button. For example, in the present embodiment, the transfer history button is pushed in a state where the wafer received in the FOUP No. 2 and the slot No. 1 is selected, so that the wafer catalog screen may be transited to the transfer history screen shown in FIG. 4. FIG. 4 represents the transfer path of the wafer in the FOUP No. 2, and transferring-to times and transferring-from times of the wafer into/from each of the chambers located on the transfer path.

The transfer path of the wafer W having the wafer identification information defined in FIG. 3 will be described with reference to FIG. 4. The FOUP No. 2 receiving the corresponding wafer W is placed on the container holding stage 115 at 16:24:29, 11/24 (16 hours 24 minutes 29 seconds, 24 November, hereinafter, represented in this way). The wafer W is transferred from the FOUP at 16:44:19. The wafer W transferred from the FOUP is transferred into the load module 120 at the same time. Here, the wafer W is held by the transfer arm 1 of the load module 120 (for example, the transfer arm Ar1 shown in FIG. 1). The wafer W held by the transfer arm 1 is transferred from the load module 120 at 16:44:27, and transferred into the location alignment unit (orienter; ORT) 125 at the same time. The location alignment unit 125 includes the rotary holding stage 125a and the optical sensor 125b which optically detects the peripheral portion of the wafer W, and aligns the location of the wafer W by detecting an orientation flat or a notch of the wafer W.

After the alignment, the wafer W is transferred from the location alignment unit 125 at 16:45:30, and transferred again into the load module 120 at the same time. Here, the wafer W is held by a transfer arm 2 of the load module 120 (for example, the transfer arm Ar2 shown in FIG. 1). After that, the wafer W is transferred from the load module 120 at 16:45:59, and transferred into the LLM 110 (LLM2) at the same time. The wafer W is transferred from the LLM 110 (LLM2) at 16:46:24, and transferred into the T/C 130 at the same time. Here, the wafer W is held by a transfer arm 2 of the T/C 130 (for example, the transfer arm Ar4 shown in FIG. 1). After that, the wafer W is transferred from the T/C 130 at 16:46:42, and transferred into the process module PM1 at the same time.

After a predetermined plasma process, the wafer W is transferred from the process module PM1 at 16:47:21, and transferred into the T/C 130 at the same time. Here, the wafer W is held by the transfer arm 2 of the T/C 130 (for example, the transfer arm Ar4 of FIG. 1). After that, the wafer W is transferred from the T/C 130 at 16:47:38, and transferred into the LLM1 105 at the same time. The wafer W is held by the transfer arm 1 of the load module 120 (for example, the transfer arm Ar1 of FIG. 1), and then is transferred from the LLM1 105 at 16:48:35 and transferred into the load module 120 at the same time. After that, the wafer W is transferred from the load module 120 at 16:48:40 and transferred into the FOUP at the same time.

As described above, transfer paths of a normal wafer and an abnormal wafer may be checked. In addition, in order to identify a process log of the corresponding wafer, a process log catalog display button on the screen shown in FIG. 4 is pushed. Accordingly, the wafer catalog screen is transited to the process log catalog of FIG. 5. The process log catalog shows wafer identification information (PJID and CJID) of 25 sheets of wafers W in one lot, a lot start date and time, and a lot finish date and time. However, FIG. 5 exemplarily shows 10 sheets of wafers W.

(Operations of the Equipment Computer)

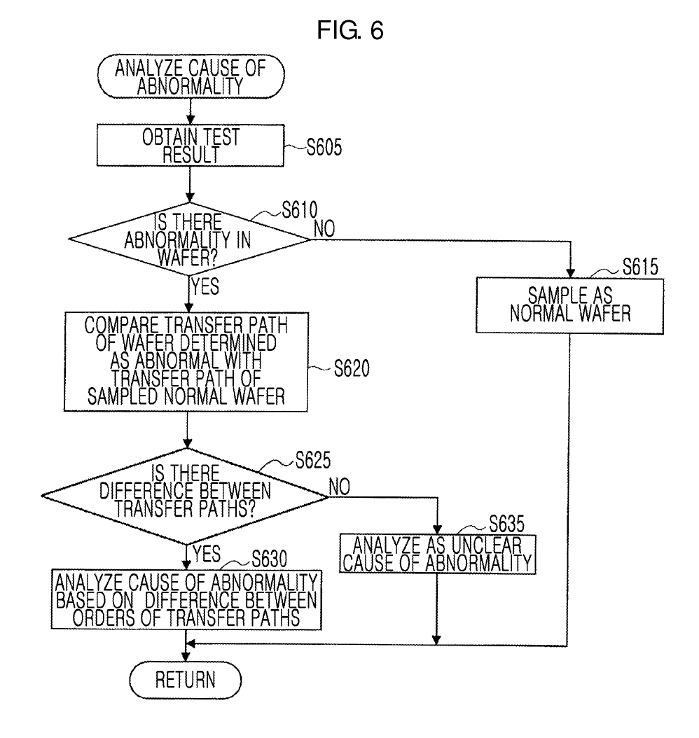

Next, operations of the equipment computer 200 according to the present embodiment will be described with reference to a flowchart of FIG. 6 showing a process of analyzing causes of abnormality. When the process of analyzing causes of abnormality is started, a test result of a wafer W transmitted from the tester 165 is obtained (S605), and it is determined whether the wafer W has an abnormality (S610). When it is determined that the wafer W has no abnormality, the wafer W is sampled as a normal wafer (S615), and the process is terminated. If it is determined that the wafer W has an abnormality, a transfer path of the wafer determined to be abnormal (abnormal wafer) is compared with a transfer path of the normal wafer sampled (S620). Here, the transfer path refers to a path of the wafer W transferred from the FOUP, transferred to at least any one of the two or more processing chambers (six chambers in the present embodiment), and returned to the FOUP. Information of the transfer path of each of the wafers uses the transfer path information of each wafer W stored in the HDD 215 in relation to the wafer identification information.

As a result of comparison, if it is determined that there is a difference between the transfer paths of the abnormal wafer and the normal wafer, the causes of abnormality are analyzed based on a difference between orders of the transfer paths (S630), and the process is terminated. On the other hand, if it is determined that there is no difference between the transfer paths, the causes of abnormality are analyzed as being indistinct (S635), and the process is terminated.

### Analyzing of Causes of Abnormality

### Example 1

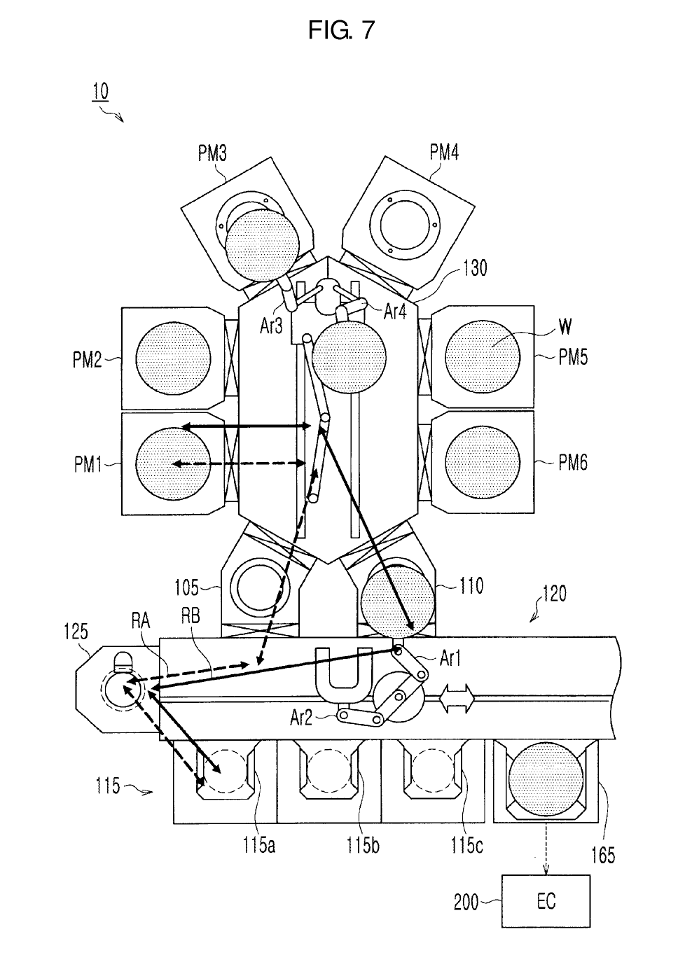

Here, a detailed example 1 of the analyzing of the causes of abnormality based on a difference between the orders of the transfer paths (S630) will be described with reference to FIG. 7. The transfer path of the normal wafer is denoted by dotted lines, and the transfer path of the abnormal wafer is denoted by solid lines. Here, it is assumed that there are a normal wafer A transferred along a transfer path RA and an abnormal wafer B transferred along a transfer path RB. The wafer B is determined to be the abnormal wafer because a lot of particles are detected.

The transfer path RA of the normal wafer A denoted by the dotted lines is a path including the FOUP 115a→the load module 120→the location alignment unit 125→the load module 120→the LLM1 105→the T/C 130→the process module PM1→the T/C 130→the LLM1 105→the load module 120→the FOUP 115a.

The transfer path RB of the abnormal wafer B denoted by the solid lines is a path including the FOUP 115a→the load module 120→the location alignment unit 125→the load module 120→the LLM2 110→the T/C 130→the process module PM1→the T/C 130→the LLM2 110→the load module 120→the FOUP 115a.

The difference between orders of the transfer path RA of the normal wafer A and the transfer path RB of the abnormal wafer B is that the abnormal wafer B is transferred via the LLM2 110 while the normal wafer A is transferred via the LLM1 105.

Therefore, as a result of the analyzing of the causes of abnormality, it may be assumed that the LLM2 110 through which only the abnormal wafer B is transferred has a source of the particles. Thus, it may be determined that cleaning of the LLM2 110 is necessary, for example.

### Analyzing of Causes of Abnormality

### Example 2

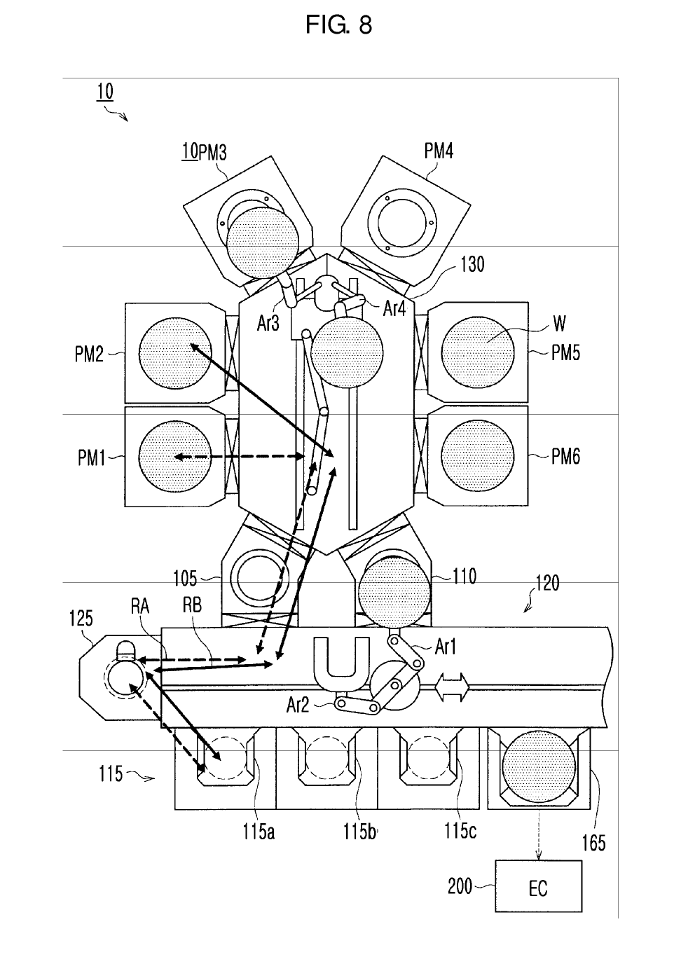

A detailed example 2 of the analyzing of the causes of abnormality will be described with reference to FIG. 8. Like the above example 1, it is assumed that there are the normal wafer A transferred along a transfer path RA and the abnormal wafer B transferred along a transfer path RB. The wafer B is determined to be the abnormal wafer because a lot of particles are detected.

The transfer path RA of the normal wafer A denoted by dotted lines of FIG. 8 is a path including the FOUP 115a→the load module 120→the location alignment unit 125→the load module 120→the LLM1 105→the T/C 130→the process module PM1→the T/C 130→the LLM1 105→the load module 120→the FOUP 115a.

The transfer path RB of the abnormal wafer B denoted by solid lines of FIG. 8 is a path including the FOUP 115a→the load module 120→the location alignment unit 125→the load module 120→the LLM1 105→the T/C 130→the process module PM2→the T/C 130→the LLM1 105→the load module 120→the FOUP 115a.

The difference between orders of the transfer path RA of the normal wafer A and the transfer path RB of the abnormal wafer B is that the abnormal wafer B is processed by plasma in the process module PM2 while the normal wafer A is processed by plasma in the process module PM1.

Therefore, as a result of the analyzing of the causes of abnormality, it may be assumed that the process module PM2 to which only the abnormal wafer B is transferred has a source of the particles. Thus, it may be determined that cleaning of the process module PM2 is necessary, for example.

In the present embodiment, the information about the transfer path of each wafer W is stored in the HDD 215 in relation to the wafer identification information. Therefore, according to the present embodiment, when analyzing the causes of abnormality, the transfer path linked with the wafer identification information (for example, the wafer ID) and stored in the HDD 215 is displayed on the screen so that an analyzer may identify the transfer path RA of the normal wafer A and the transfer path RB of the abnormal wafer B, or the wafer identification information (for example, the wafer ID) of the normal wafer A and the abnormal wafer B is input so that the CPU 220 may automatically detect a difference between the orders of the transfer paths.

As described above, in the plasma processing system 10 of the cluster type according to the present embodiment, the information of the transfer path of each wafer W in relation to the wafer identification information is stored in the HDD 215. Accordingly, as a result of the test, the transfer path of the wafer W that is determined to be abnormal and the transfer path of the wafer W that is determined to be normal are compared with each other, and the causes of abnormality may be analyzed based on a comparison result.

### Another Embodiment

### Operations of the Equipment Computer

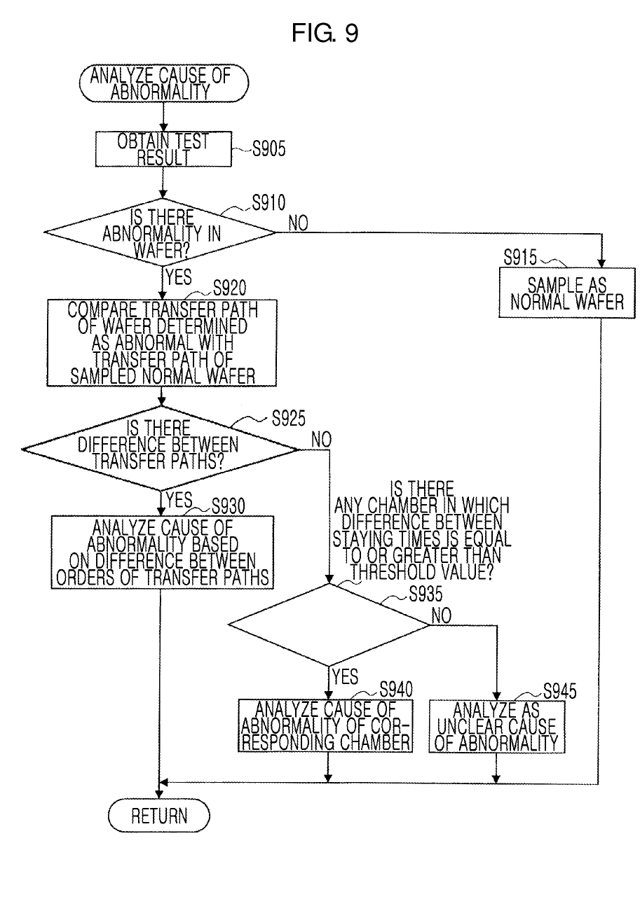

Next, operations of the equipment computer 200 according to another embodiment of the present invention will be described with reference to FIG. 9, which is a flowchart showing a process of analyzing causes of abnormality. In addition, hardware configurations of the plasma processing system 10 and the equipment computer 200 in the present embodiment are the same as those of the previous embodiment, and thus, descriptions of the plasma processing system 10 and the equipment computer 200 are not provided here.

When the process of analyzing the causes of abnormality starts, a test result of the wafer W transmitted from the tester 165 is obtained (S905), and it is determined whether the wafer W has an abnormality (S910). If it is determined that the wafer W has no abnormality, the wafer W is sampled as a normal wafer (S915), and the process is terminated. If it is determined that the wafer W has an abnormality, a transfer path of the wafer that is determined as abnormal (abnormal wafer) is compared with a transfer path of the normal wafer sampled (S920). In the present embodiment, a time during which the wafer W stays in each of the chambers on the transfer path is stored in the HDD 215 in addition to the transfer path of each wafer W. In the present embodiment, information about the transfer path and the staying time of the wafer W in each of the chambers on the transfer path are both used.

As a result of comparison, if it is determined that there is a difference between the transfer paths (S925), the causes of abnormality are analyzed based on the difference between the transfer paths (S930), and the process is terminated. On the other hand, if it is determined that there is no difference between the transfer paths (S925), it is determined whether there is each chamber on the transfer path, in which a difference between the staying times of the normal wafer and the abnormal wafer exceeds a predetermined threshold value (S935). If it is determined that there is such a chamber in which the difference between the staying times is equal to or greater than the threshold value, the causes of abnormality of the corresponding chamber are analyzed (S940), and the process is terminated. If it is determined that there is no such chamber in which the difference between the staying times is equal to or greater than the threshold value, the causes of abnormality are analyzed as being indistinct (S945), and the process is terminated.

### Analyzing the Causes of Abnormality

### Example 3

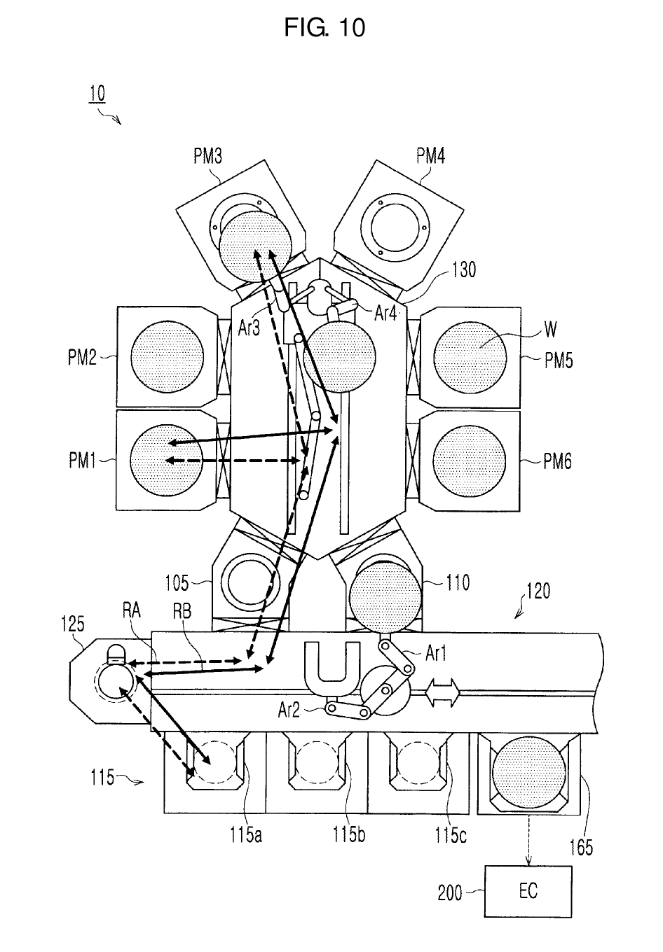

Here, a detailed example 3 of analyzing of the causes of abnormality based on a difference between the staying times of the normal wafer and the abnormal wafer (S935 and S940) will be described with reference to FIG. 10. It is assumed that there are a normal wafer A transferred along a transfer path RA and an abnormal wafer B transferred along a transfer path RB. The wafer B is determined to be the abnormal wafer because there is a difference between etching shapes caused by a residual gas in a predetermined chamber.

The transfer path RA of the normal wafer A and the transfer path RB of the abnormal wafer B both are paths denoted by dotted lines and solid lines of FIG. 10 including the FOUP 115a→the load module 120→the location alignment unit 125→the load module 120→the LLM1 105→the T/C 130→the process module PM1→the T/C 130→the process module PM3→the T/C 130→the LLM1 105→the load module 120→the FOUP 115a.

As described above, in the example 3, there is no difference between orders of the transfer path RA of the normal wafer A and the transfer path RB of the abnormal wafer B. However, the time during which the wafer A or B stays in each of the chambers (each chamber such as the LLM or the T/C) on the transfer path is calculated by using the transferring-to times and transferring-from times of the chambers shown in FIG. 4. Then, as a result of the calculation, if a difference between the staying times of the normal wafer A and the abnormal wafer B in the process module PM1 is greater than a threshold value, it is determined that the process module PM1 has a source of abnormality. That is, since the abnormal wafer B stays in the process module PM1 longer than the normal wafer A, it may be assumed that the difference between the etching shapes of the wafers is detected due to the residual gas in the process module PM1. Therefore, it may be determined that cleaning of the process module PM1 is necessary, for example.

In addition, for example, when a difference between the staying time of the normal wafer A in the FOUP 115a and the staying time of the abnormal wafer B in the FOUP 115b is greater than a threshold value, it may be analyzed that the FOUP 115b has a cause of abnormality. That is, since the time during which the abnormal wafer B stays in the FOUP 115b is longer than the time during which the normal wafer A stays in the FOUP 115a, it may be assumed that a difference between the etching shapes of the wafers is detected due to the residual gas in the FOUP 115b. Therefore, it may be determined that cleaning of the FOUP 115b is necessary, for example. Likewise, an effect of the residual gas in the location alignment unit 125 or in the LLMs 105 and 110 may be analyzed.

As described above, according to the plasma processing system 10 of the cluster type of the present embodiment, information about the staying time of each of the wafers W in each of the chambers on the transfer path, in addition to the transfer path of each wafer W, is stored in the HDD 215 in relation to the wafer identification information of each wafer W. Accordingly, as a result of the test, the causes of abnormality may be analyzed based on the difference between the stored staying time of the wafer W that is determined to be abnormal in the plasma process and the stored staying time of the wafer W that is determined to be normal. Accordingly, even when the transfer paths of the abnormal wafer and the normal wafer are the same as each other, the causes of abnormality may be analyzed based on the difference between the staying times. Therefore, a characteristic of the causes of abnormality may be predicted based on the analyzing result, and thus, a treatment for removing the causes of abnormality may be performed rapidly. Thus, an operating rate of the plasma processing system may be improved.

In the method of analyzing the causes of abnormality according to the previous embodiment, the wafer identification information (for example, the wafer ID) and the information of the transfer path are stored in the HDD 215 in relation to each other. In addition, in the method of analyzing the causes of abnormality according to the present embodiment, in addition to the transfer path of each of the wafers W, the time during which each of the wafers W stays in each of the chambers on the transfer path is stored in the HDD 215.

However, the history information stored in the HDD 215 for analyzing the causes of abnormality is not limited to the transfer path or the staying time in each of the chambers on the transfer path. For example, the two or more transfer arms that respectively transfer the wafer W in the same transfer chamber may be used as a kind of history information for analyzing the causes of abnormality.

Therefore, the HDD 215 may store at least one selected from the group consisting of the history information about the staying time on the transfer path and the history information of each kind of the transfer arms on the transfer path linked with the wafer ID (wafer identification information), in addition to the history information of the transfer path. In addition, the HDD 215 may hold information of the wafer W determined to be abnormal as comparative information in analyzing the causes of abnormality.

According to the method, for example, even when the normal wafer A is transferred by the transfer arm Ar3 shown in FIG. 1 and the abnormal wafer B is transferred by the transfer arm Ar4, the causes of abnormality may be analyzed by using the history information of each kind of the transfer arms disposed on the transfer path.

For example, when only the test result of the wafer W transferred by the transfer arm Ar4 is determined to be abnormal, for example, particles are deposited on a rear surface of the wafer W transferred by the transfer arm Ar4, it may be analyzed that the transfer arm Ar4 is defective.

A material for preventing the wafer from sliding on a transfer arm is coated on a surface of the transfer arm. If the transfer arm transfers the wafer in a state where the coating is deteriorated, the location of the wafer may be dislocated. Therefore, when the wafer is placed on the holding stage of a processing chamber or placed on the location alignment unit, the wafer may be dislocated from a specified location. If the wafer transferred by a certain transfer arm is only dislocated and the holding location of the wafer is not constant, it may be analyzed that the deterioration of the coating is a cause of abnormality.

In the above embodiments of the present invention, operations of the equipment computer 200 are related to each other, and thus, may be replaced with a series of processes in consideration of the relations with each other. Accordingly, the embodiment of the method of analyzing causes of abnormality may be an embodiment of a program analyzing an abnormality for executing processing function of each of the steps in the method in a computer and a non-transitory computer-readable medium having embodied thereon the program.

Accordingly, a non-transitory computer-readable medium storing an abnormality analyzing program for executing a function of analyzing the causes of abnormality of a processing target that is processed by plasma in at least any one of two or more processing chambers disposed in a plasma processing system of a cluster type in a computer may be provided. The function of analyzing the causes of abnormality includes recording information about a transfer path of the processing target from when the processing target is transferred from a FOUP and transferred to at least any one of the two or more processing chambers to when the processing target is returned to the FOUP, in relation with identification information of the processing target, testing a state of the processing target after the plasma process has finished, and analyzing the causes of abnormality by comparing the information about the transfer path of the processing target corresponding to when the processing target is determined to be abnormal as a result of the test with the information about the transfer path of the processing target corresponding to when the processing target is determined as normal, and analyzing the causes of abnormality based on the comparison result.

As described above, according to the present invention, a cause of abnormality of a wafer processed by plasma may be analyzed.

While this invention has been particularly shown and described with reference to exemplary embodiments thereof and drawings, it will be understood by those skilled in the art that various changes in form and details may be made therein without departing from the spirit and scope of the invention as defined by the appended claims.

The process module according to the present invention may be used in an etching apparatus, a film forming apparatus, an ashing apparatus, a microwave plasma processing apparatus, or the like. In the above apparatuses, the plasma process is performed on a wafer or a substrate that is a processing target.

What is claimed is:

1. A method of analyzing a cause of abnormality of a processing target that is processed by plasma in at least any one of two or more processing chambers disposed in a plasma processing system of a cluster type, the method comprising:
recording information about transfer paths of the processing target from when the processing target is transferred from a shipping container and transferred to at least any one of the two or more processing chambers to when the processing target is returned to the shipping container, in relation with identification information of the processing target for each processing target;
testing a state of the processing target after a plasma process has finished; and
analyzing a cause of abnormality based on a result of comparison between a recorded information about a transfer path of the processing target that is determined to be abnormal and a recorded information about a transfer path of the processing target that is determined to be normal as a result of the testing.

2. The method of claim 1, wherein the analyzing of the cause of abnormality is performed based on a difference of the transfer paths between the information about the recorded transfer path of the processing target determined to be abnormal and the information about the recorded transfer path of the processing target determined to be normal.

3. The method of claim 1, wherein the recording comprises recording a time during which the processing target transferred along the transfer path stays in each of chambers on the transfer path, and the analyzing of the cause of abnormality is performed based on a difference between a recorded staying time of the processing target determined to be abnormal in each of the chambers and a recorded staying time of the processing target determined to be normal in each of the chambers.

4. The method of claim 1, wherein the testing is for detecting particles on the processing target after the plasma process has finished.

5. The method of claim 1, wherein the testing is for checking a shape of a film on the processing target after the plasma process has finished.

6. The method of claim 1, wherein the plasma processing system comprises two or more transfer arms transferring respectively the processing target in a transfer chamber connecting the two or more processing chambers.

7. The method of claim 1, wherein the plasma processing system comprises two or more loadlock modules connecting a processing side system including the two or more processing chambers and a transfer side system.

8. A non-transitory computer-readable medium having embodied thereon an abnormality analyzing program for executing a function of analyzing a cause of abnormality of a processing target that is processed by plasma in at least any one of two or more processing chambers disposed in a plasma processing system of a cluster type, wherein the function of analyzing the cause of abnormality comprises:
recording information about transfer paths of the processing target from when the processing target is transferred from a shipping container and transferred to at least any one of the two or more processing chambers to when the processing target is returned to the shipping container, in relation with identification information of the processing target for each processing target;
testing a state of the processing target after a plasma process has finished; and
analyzing a cause of abnormality based on a result of comparison between a recorded information about a transfer path of the processing target that is determined to be abnormal and a recorded information about a transfer path of the processing target that is determined to be normal as a result of the testing.

9. An apparatus for analyzing a cause of abnormality of a processing target that is processed by plasma in at least any one of two or more processing chambers provided in a plasma processing system of a cluster type, the apparatus comprising:
a recording unit for storing information about transfer paths of the processing target from when the processing target is transferred from a shipping container and transferred to at least any one of the two or more processing chambers to when the processing target is returned to the shipping container, in relation with identification information of the processing target for each processing target;
a tester for testing a state of the processing target after a plasma process has finished; and
a controller for analyzing a cause of abnormality based on a result of comparison between a recorded information about a transfer path of the processing target that is determined to be abnormal and a recorded information about a transfer path of the processing target that is determined to be normal as a result of the testing.
